(19) United States
(12) Patent Application Publication
(10) Pub. No.: US 2026/0074771 A1
(43) Pub. Date: Mar. 12, 2026

(54) ENVIRONMENT SEMANTIC COMMUNICATION AND COMMUNICATION USER IDENTIFICATION: ENABLING DISTRIBUTED SENSING AIDED NETWORKS AND MULTI-USER VISION-AIDED COMMUNICATIONS

(71) Applicant: ARIZONA BOARD OF REGENTS ON BEHALF OF ARIZONA STATE UNIVERSITY, Scottsdale, AZ (US)

(72) Inventors: Ahmed Alkhateeb, Chandler, AZ (US); Gouranga Charan, Tempe, AZ (US); Shoaib Imran, Tempe, AZ (US)

(73) Assignee: ARIZONA BOARD OF REGENTS ON BEHALF OF ARIZONA STATE UNIVERSITY, Scottsdale, AZ (US)

(21) Appl. No.: 19/322,892

(22) Filed: Sep. 9, 2025

Related U.S. Application Data
(60) Provisional application No. 63/692,362, filed on Sep. 9, 2024.

(51) Int. Cl. H04B 7/06; H04W 28/02

(52) U.S. Cl. CPC H04B 7/06952; H04W 28/0226

(57) ABSTRACT

A system and method for identifying a communication user in a crowded scenario and support multi-user applications, and for identifying the target communication user from the other candidate objects (distractors) in the visual scene. Machine learning models process either one frame or a sequence of frames of sensor data from distributed nodes to identify the target communication user in the semantic environment. Large antenna arrays and narrow directive beams are used to ensure a receive signal power. Optimal beams for millimeter-wave (mmWave) and terahertz (THz) large antenna arrays are selected. Distributed nodes equipped with sensors to receive sensor data extract environment semantics from the captured sensor data. The semantic data are transmitted to the base station. A communication user identification and tracking process is executed at the base station.

### CROSS-REFERENCE TO RELATED APPLICATIONS

This application claims the priority and benefit of U.S. Provisional Application No. 63/692,362, filed on Sep. 9, 2024, which is hereby incorporated by reference in its entirety.

### GOVERNMENT FUNDING

This invention was made with government support under contract number 2048021 awarded by the National Science Foundation. The government has certain rights in the invention.

### FIELD OF THE DISCLOSURE

The present disclosure is directed to wireless communications, and more specifically, communications resources between a base station and a communication user.

### BACKGROUND

The use of millimeter wave (mmWave) and subterahertz (sub-THz) bands meet the demanding data needs of 5G and future technologies. These systems rely on the use of large antenna arrays and narrow directive beams at both the communication user and receiver to guarantee sufficient receive power. Selecting the optimal beams for these large antennas is associated with training overhead. This makes it challenging for mmWave/THz communication systems to support highly mobile wireless applications such as virtual/augmented reality and connected vehicles. High frequency signals are dependent on direct, line-of-sight (LOS) paths to achieve sufficient receive power. Obstacles in the environment that block these LOS links can interrupt communication or degrade the link quality because of the penetration loss of mmWave/sub-terahertz signals, which reduces the received power for non-line-of-sight (NLOS) links. Leveraging machine learning (ML) to address these challenges has gained increasing interest in the last few years. The role of ML (and artificial intelligence (AI) in general) in tackling problems such as beam training overhead, the sensitivity of mmWave/sub-THz signals to blockages, and demands for low-latency communications has been investigated using wireless signals. These solutions are limited in their ability to scale to complex/crowded, or realistic scenarios. ML-based approaches leverage side information to overcome the challenges associated with the mmWave/sub-THz communication systems. In order to predict blockages early enough, i.e., before they block the links, solutions based on vision, radar, and LiDAR sensory data have been proposed. For fast mmWave/sub-THz beam prediction, solutions based on vision, position, radar, and LiDAR have been proposed. Sensing-aided wireless communication solutions accommodate single-candidate scenarios.

What are needed are sensing-aided wireless communication solutions that can scale to real-world scenarios with multiple objects in the sensing scene. What are needed are systems that operate in multi-candidate and multi-user settings. What are needed are machine learning models that demonstrate an understanding of the wireless environment to be able to predict optimal beam indices correctly. The machine learning models identify the probable communication user candidate among the different objects in the environment. The machine learning models leverage sensing data such as position or wireless receive power to identify a target communication user. Solutions have been proposed to mitigate/minimize the beam training and channel estimation overhead. Efforts have primarily centered on creating adaptive beam codebooks, formulating beam tracking techniques, and exploiting channel sparsity with compressive sensing tools. Other system involve the calculation of a beamforming matrix from an estimated channel matrix. Channel state information (CSI)-based approaches encounter challenges in addressing the complexities of future wireless networks, relying on stable and predictable channel characteristics, which are increasingly untenable in high-frequency mmWave and sub-THz domains. As these frequencies are more susceptible to environment factors such as physical obstructions and atmospheric conditions, maintaining the CSI is challenging. This is particularly problematic in urban environments or scenarios with high user mobility, where the channel conditions can change rapidly and unpredictably. Furthermore, training and feedback to estimate and update the CSI add overhead, which is exacerbated in large antenna array systems. The overhead impacts the system's capacity to support real-time, latency-sensitive applications in B5G and 6G networks. Initial approaches for overcoming these blockage challenges relied mainly on multi-connectivity. These solutions generally keep the communication user connected to multiple infrastructure nodes, which under-utilizes the wireless network resources. Recent advancements in addressing link blockage in wireless networks have primarily explored Reconfigurable Intelligent Surfaces (RISs), including technologies like Simultaneous Transmitting and Reflecting RIS (STAR-RIS), and Backscatter Communication. These techniques rescue communication users from dead zones by bypassing obstructions. The challenge with link blockage is its abrupt occurrence, leading to sudden disruptions in link quality and resultant delays in communication. A limitation of existing solutions, including RISs and backscatter, is their passive response to such disruptions, which mitigates the issue post occurrence. What is needed is to anticipate and adapt to potential blockages before they impact the network, thus ensuring seamless connectivity and minimizing latency. What are needed are ML approaches that leverage prior observation and side information, such as receive signal signature, communication user position, and visual/camera images for fast mmWave/THz beam prediction and efficient blockage avoidance approaches. What is needed is to improve the quality of service in next generation wireless networks by integrating ML techniques and diverse sensing data, and applying the integration to sensing-aided beam and blockage prediction, for example. What is needed is to characterize current and future channels to determine terminal positions, mobility patterns, and the dynamics of the surrounding environment. What is needed is to discern the likely communication user among various objects through the use of models that operate in complex scenarios, which typically feature a multitude of communication user candidates.

Utilizing frequency bands, such as mmWave in 5G and possibly sub-terahertz in 6G, is a trend in current and future communication systems. These frequency ranges enable the communication systems to meet the data rate demands of emerging applications such as augmented/virtual reality, autonomous vehicles, and smart cities. These systems use large antenna arrays and narrow beams at both the communication user and receiver to ensure adequate receive signal power. Selecting beams for these large antenna arrays incurs a training overhead, making it challenging to satisfy the low-latency and high-reliability requirements of these current and future applications. Approaches that (i) reduce or mitigate the training overhead associated with beam selection and (ii) enable highly mobile wireless communication applications can be used. Several solutions have been proposed to reduce the beam training and channel estimation overhead in mmWave communication systems. The focus of these solutions has been mainly on:
(i) the development of beam training with adaptive/hierarchical beam codebooks;
(ii) the utilization of sensing tools to estimate the full channel with a much smaller number of measurements; this is motivated by the sparse nature of the mmWave channels, where a few dominant paths exist between the communication user and receiver; and
(iii) the design of beam tracking techniques that leverage the communication user mobility information to predict the future beams and hence reduce the search beam training overhead.

These classical approaches may result in a training overhead reduction of one order of magnitude, which may not be sufficient for very large antenna array systems and applications that require very low-latency. The challenges faced by classical solutions have led to the development of ML approaches that leverage prior observation and additional sensing information. The additional sensing modalities include position (GPS location), RGB images, LiDAR, and radar. The additional sensing information provides an environment context, enabling an in-depth comprehension of the wireless environment and its influence on channel characteristics. Prior studies have demonstrated the potential of utilizing additional side information in minimizing the beam training overhead. The solutions are primarily designed for scenarios with a single object of interest, which can be challenging when scaling them to real-world situations with multiple objects. The additional sensors used in the solutions, such as cameras, LiDAR, and radar, are positioned at the base station and have a range of approximately 60-80 meters. This range is shorter than the typical range of the mmWave communication systems, which is around 300 meters. Consequently, this limited range of these additional sensing modalities significantly impacts the effectiveness of these solutions in real-world wireless communication tasks (such as beam prediction and proactive blockage prediction). Additionally, these sensors may not provide coverage for non-line-of-sight scenarios, restricting their applicability in diverse environments. One solution to overcome these challenges is deploying multiple nodes equipped with sensors, to capture information about the wireless environment in a coordinated manner. This distributed sensing approach enhances coverage, reliability, and adaptability by strategically distributing sensors throughout the network. Instead of relying on sensors at the base station, data collected by these distributed nodes can be utilized by one or more base stations to make informed decisions. This scalable approach leverages the collective sensing capabilities of multiple nodes, providing a comprehensive view of the wireless environment and optimizing tasks such as beam prediction and proactive blockage prediction. As the number of distributed nodes increases, challenges may arise in managing the growing volume of captured data, including storage, processing, and transmission concerns. Furthermore, the heightened data rate resulting from the increased number of nodes necessitates robust data synchronization methods to maintain temporal coherence.

One way to address these challenges is by processing the data captured by the distributed nodes locally, either at the edge or in the cloud. This involves extracting information, referred to as “environment semantics”, from the raw sensor data. Environment semantics encompass meaningful details about the wireless environment, which includes the number, type, and shape of the objects, among other relevant attributes. As such, these environment semantics can represent the information within the wireless environment while also minimizing the data storage requirement as compared to the original sensing modality. Federated learning entails training models across decentralized devices using local data, with the aggregated insights refining the overall model while maintaining data privacy and minimizing bandwidth use. Distributed AI and edge computing have shown potential in enhancing network functionalities. These technologies have been effective in managing the data from distributed nodes, addressing challenges in data processing and storage.

What is needed are systems and methods that use environment semantics to enable distributed sensing-aided wireless communication in real-world scenarios to predict optimal beams in a real-world wireless communication setting accurately. What are needed are (1) a sensing-aided beam prediction for a vehicle-to-infrastructure (V2I) communication scenario with multiple distributed nodes equipped with an RGB camera to capture the wireless environment, (2) a deep learning-based solution that leverages images captured by cameras installed at distributed nodes to accurately predict the optimal beam index at the base station in a V2I communication scenario, (3) using various environment semantics that can be extracted from images, such as object bounding boxes and masks, to enable distributed sensing-aided wireless communication, and (4) evaluating the distributed environment semantic-aided beam prediction based on a scenario in a DeepSense 6G dataset. The scenario may focus on the distributed aspect, capturing co-existing multi-modal data from the base station and two distributed units, offering a comprehensive dataset that enables the study of distributed sensing-aided wireless communication.

### SUMMARY

Systems and methods in accordance with embodiments of the present disclosure identify a single communication user in a multi-candidate environment using visual and radio data. The system and method distinguish between objects that are transmitting and receiving radio signals in the wireless environment (“communication users”) from non-transmitting or non-receiving objects (“distractors”). The system and method identify communication users by evaluating complicated, real-world scenarios, based on a large-scale dataset. The system and method analyze information from a dataset, and then a sequence of image and wireless data samples. The system and method identify the communication user to an accuracy of approximately 90% based on information obtained from the analysis. The system and method repair environment blockages that mmWave/sub-THz signals are highly sensitive to by using large antennae arrays and narrow directed beams to ensure a sufficient receive signal-to-noise ratio (SNR). The ML approaches described herein (i) detect the objects of interest in the wireless environment and (ii) identify the communication user in the visual scene among the different objects in the environment. The system and method evaluate sensing-aided communication user identification based on a large-scale dataset that includes co-existing multi-modal sensing and wireless communication data.

Systems and methods in accordance with embodiments of the present disclosure include a machine learning (ML) solution to beam training overhead in mmWave communication systems. Multiple distributed sensing nodes equipped with sensors such as, for example, but not limited to, an RGB camera, are used to extract environment semantics from captured RGB images. The collected semantic data may be transmitted to a base station, and processed via mathematical models to determine an optimal beam index. The systems and methods include a beam prediction model that uses data from a sequence of RGB images and the ground truth wireless measurements, including, but not limited to, a receive power vector or a compressive sensing-based measurements vector, to identify a specific uniform linear array (ULA) and corresponding region where the communication user is located.

Distributed nodes sense the environment and transmit environment semantic information to a base station. The base station is equipped with sensors, for example, but not limited to, an RGB camera and three M-element uniform linear arrays (ULAs). The base station provides sensing information for the region specifically in front of it, and the nodes cover the remaining region. The communication user is equipped with a single antenna transmitter and a GPS receiver. In some configurations, three stages of processing ensue. The first stage may include environment semantics extraction in which nodes capture environment semantic data (specifically bounding boxes/Bboxes and binary masks) via RGB images, and the nodes use a pre-trained object detection and image segmentation model that allows for simultaneous generation of bounding boxes and masks such as, for example, but not limited to, YOLO1. The second stage may include communication user identification and tracking that uses a two-step process to define the transmitter/communication user. A part of the second stage may include transmitter identification in which extracted bounding boxes and a prediction function are used to find wireless measurements including, but not limited to, a receive power vector or a compressive sensing-based measurements vector, from the ULA with the communication user, and the semantic information are used with a time function to predict the center coordinates of the transmitter's bounding box. A second part of the second stage may include object association based tracking in which the transmitter's location is tracked through the data samples via (1) bbox-based object tracking, for example, but not limited to, a Euclidean distance-based object association algorithm that locates a closest bounding box to the transmitter, or (2) mask-based object tracking, for example, but not limited to, color information and semantic data combined with a Hadamard product to identify the transmitter based on color similarity. The third stage includes beam prediction. There are at least two possible approaches to beam prediction—single instance-based beam prediction that uses the bounding boxes or mask and a mapping function at a step time t to predict the corresponding beam index, and sequence-based beam prediction that uses a recurrent neural network (RNN) to process a sequence of environment semantics (the RNN utilizes a mapping function) to predict the optimal beam index.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for establishing communication resources between a base station and a communication user. The method includes collecting sensor data at one or more nodes associated with the base station, extracting environment semantics from the collected sensor data, and identifying the communication user based on the collected sensor data, the extracted environment semantics, and a prediction function. The method also includes tracking a location of the identified communication user based on user-specific features based on the environment semantics, and predicting the communication resources for the communication user based on the tracked location. Other embodiments of this aspect include corresponding computer systems, apparatus, and computer programs recorded on one or more computer storage devices, each configured to perform the actions of the methods.

Implementations may include one or more of the following features. The sensor data may include one or more of RGB images, LiDAR data, radar data, and GPS data. The environment semantics may include one or more bounding boxes, one or more binary masks, a mobility pattern of the communication user, and direction of travel of the communication user. Extracting the environment semantics may include generating, by the one or more nodes, the one or more bounding boxes and the one or more binary masks based at least on object detection and an image segmentation model. The method may include removing one or more of the one or more bounding boxes that do not contain the location of the communication user by filtering, using a nearest neighbor algorithm with a Euclidean distance metric, the one or more bounding boxes. The environment semantics may include center coordinates of the one or more bounding boxes. Extracting the environment semantics may include executing a YOLO model in the one or more nodes. Tracking the location of the identified communication user may include using data samples based on bounding box-based object tracking. The bounding box-based object tracking may include finding a closest bounding box to the communication user using a Euclidean distance-based object association algorithm. The prediction function may include a machine learning model configured to predict a probable location of the communication user. Tracking the location of the identified communication user may include tracking by user-specific features combined with a Hadamard product to identify the communication user based on color similarity. Predicting the communication resources may include single instance-based beam prediction based on bounding boxes or a mask and a mapping function at a step time to predict a communication resource index. Predicting the communication resources may include processing a sequence of the user-specific features based on a recurrent neural network (RNN). The method may include predicting a communication resources index based on a mapping function used by the RNN. The communication resources may include at least one of a communication beam, time-frequency resources, or a hand-off decision. The sensor data may include at least one of a receive power vector, or a compressive sensing-based measurements vector. Implementations of the described techniques may include hardware, a method or process, or computer software on a computer-accessible medium.

One general aspect includes a computer system for establishing communication resources between a base station and a communication user. The computer system also includes a hardware processor, and a non-volatile storage medium storing instructions that when executed by the hardware processor perform operations that may include collecting sensor data at one or more nodes associated with the base station, extracting environment semantics from the collected sensor data, identifying the communication user based on the collected sensor data, the extracted environment semantics, and a prediction function; tracking a location of the identified communication user based on user-specific features based on the environment semantics, and predicting the communication resources for the communication user based on the tracked location. Other embodiments of this aspect include corresponding computer systems, apparatus, and computer programs recorded on one or more computer storage devices, each configured to perform the actions of the methods.

Implementations may include one or more of the following features. The sensor data may include one or more of RGB images, LiDAR data, radar data, and GPS data. The environment semantics may include one or more bounding boxes, one or more binary masks, a mobility pattern of the communication user, and direction of travel of the communication user. Extracting the environment semantics may include generating, by the one or more nodes, the one or more bounding boxes and the one or more binary masks based at least on object detection and an image segmentation model. The operations may further include removing the one or more of the one or more bounding boxes that do not contain the location of the communication user by filtering, using a nearest neighbor algorithm with a Euclidean distance metric, the one or more bounding boxes. Implementations of the described techniques may include hardware, a method or process, or computer software on a computer-accessible medium.

One general aspect includes a computer program product for establishing communication resources between a base station and a communication user. The computer program product includes a computer readable storage medium having program instructions embodied therewith, the program instructions executable by a computing device to cause the computing device to perform operations including collecting sensor data at one or more nodes associated with the base station, extracting environment semantics from the collected sensor data, identifying the communication user based on the collected sensor data, the extracted environment semantics, and a prediction function. The operations also include tracking a location of the identified communication user based on user-specific features based on the environment semantics, and predicting the communication resources for the communication user based on the tracked location. Other embodiments of this aspect include corresponding computer systems, apparatus, and computer programs recorded on one or more computer storage devices, each configured to perform the actions of the methods.

It is to be understood that both the foregoing general description and the following detailed description are exemplary and explanatory and are not restrictive of the present teachings, as claimed.

### BRIEF DESCRIPTION OF THE DRAWINGS

The accompanying drawings, which are incorporated in and constitute a part of this specification, illustrate aspects of the present teachings and together with the description, serve to explain the principles of the present teachings.

FIG. 1 is a pictorial illustration of objects that can be identified as the communication user(s) from which the communications user is detected by embodiments in accordance with the present disclosure;

FIG. 2 is a pictorial block diagram of a multimodal user identification framework that integrates visual data from a millimeter-wave (mmWave) base station equipped with a camera and wireless receive power vector, where a system and method in accordance with embodiments of the present disclosure identify a target communication user from among several potential candidates by analyzing an image sequence and mmWave receive power over time through a machine learning (ML) model;

FIG. 3 is a pictorial block diagram of a single sample-based communication user identification model that leverages both visual and wireless data to predict the communication user in the scene;

FIG. 4 is a pictorial block diagram of the sequence of operations of a communication user identification model in accordance with embodiments of the present disclosure;

FIG. 5 is a pictorial representation of the system with distributed nodes extracting environment semantic information from the RGB images, and transmitting it to the base station, where it is used for beam prediction at the base station;

FIG. 6 is a pictorial representation of the selection process of the ULA, the sub-region, and the corresponding distributed node;

FIG. 7 is a photographic representation of the stages of a method in accordance with embodiments of the present disclosure, namely extracting environment semantics from the raw RGB images and transmitting the semantics to the base station, identifying the transmitter in a frame and tracking the transmitter over subsequent frames, and using the semantic information of the transmitter for beam prediction;

FIG. 8 is a pictorial representation of the environment semantics extraction stage of a method in accordance with embodiments of the present disclosure, including a camera installed at the distributed node capturing real-time images of the wireless environment, in which a machine learning model processes the real-time images to extract the bounding boxes and masks of the mobile objects present in the images;

FIG. 9 is a pictorial representation of the transmitter identification and object association-based tracking process in which the transmitter is identified in the frame using the receive power vector and then tracked for the remaining frames using the nearest neighbor algorithm;

FIGS. 10A and 10B are schematic block diagrams of the RNN models for beam prediction including a first RNN model, shown in FIG. 10A, taking the bounding boxes of the transmitter as input, in which the units include an LSTM block and a classifier block, and in which the RNN model FIG. 10B takes masks of the transmitter as input, and in which the units include an embedding block, an LSTM block, and a classifier block;

FIG. 11 is a table comparing ML models or beam prediction in accordance with embodiments of the present disclosure;

FIG. 12 is a flowchart of a method in accordance with embodiments of the present disclosure.

It should be noted that some details of the figures have been simplified and are drawn to facilitate understanding rather than to maintain strict structural accuracy, detail, and scale.

### DESCRIPTION

Reference will now be made in detail to the present teachings, examples of which are illustrated in the accompanying drawings. In the drawings, like reference numerals have been used throughout to designate identical elements. In the following description, reference is made to the accompanying drawings that form a part thereof, and in which is shown by way of illustration specific examples of practicing the present teachings. The following description is, therefore, merely exemplary. The developed technology is crafted with a profound comprehension of language learning as an inclusive process, spanning speaking, listening, reading, and writing. It surpasses basic auditory processing by incorporating a variety of sensory inputs to enhance every facet of language acquisition.

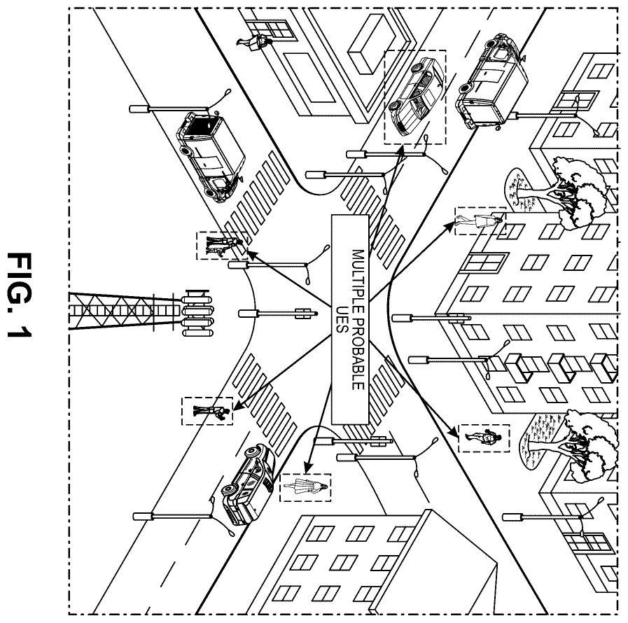

Referring now to FIG. 1, sensing-aided communication systems operate in multi-candidate and multi-user settings. To illustrate this, consider the example of a sensing-aided beam prediction task. From the base station perspective, there can be multiple relevant objects in the wireless environment. Any of those objects can be the object of interest (the communication user). Therefore, the ML models demonstrate a deep understanding of the wireless environment to be able to predict the optimal beam indices correctly. The model identifies the probable communication user candidate among the different objects in the environment. This can be done by using sensing information (attributes) for the communication user. What is needed is to anticipate and adapt to potential blockages before they impact the network, thus ensuring seamless connectivity and minimizing latency. ML approaches leverage prior observation and side information, such as receive signal signature, communication user position, and visual/camera images for fast mmWave/THz beam prediction and efficient blockage avoidance approaches. To improve the quality of service in next generation wireless networks, ML techniques are integrated with diverse sensing data. Capturing environment features includes deploying various sensing modalities, including vision, communication user position, LiDAR, and radar, which can effectively sense the wireless environment. To transition sensing-aided solutions from single-candidate to multi-user environments, the likely communication user is discerned among various objects. Visual sensing can be used to discern the likely communication user. The communication user identification problem is formulated in vision-aided mmWave/THz wireless communication networks considering practical visual and communication models. ML models can detect the objects of interest in the wireless environment and identify the communication user in the visual scene among the different objects in the environment. The model can enable adaptation to unseen scenarios, and maintaining communication user identification accuracy even when trained data from the scenario is absent. Sensing-aided communication user identification is evaluated based on a large-scale dataset such as, for example, but not limited to, DeepSense 6G, that includes co-existing multimodal sensing and wireless communication data. The ability to identify the communication user in the scene enables the network to make proactive beam/base station switching decisions and predict future line-of-sight link blockage, enhancing the overall network reliability and latency performance. The communication system distinguishes between objects transmitting/receiving radio signals in the wireless environment (hereafter referred to as communication users) and non-transmitting/non-receiving objects (referred to as the distractors). This ability to identify the objects of interest or the communication users in the wireless environment is referred to as the communication user identification task.

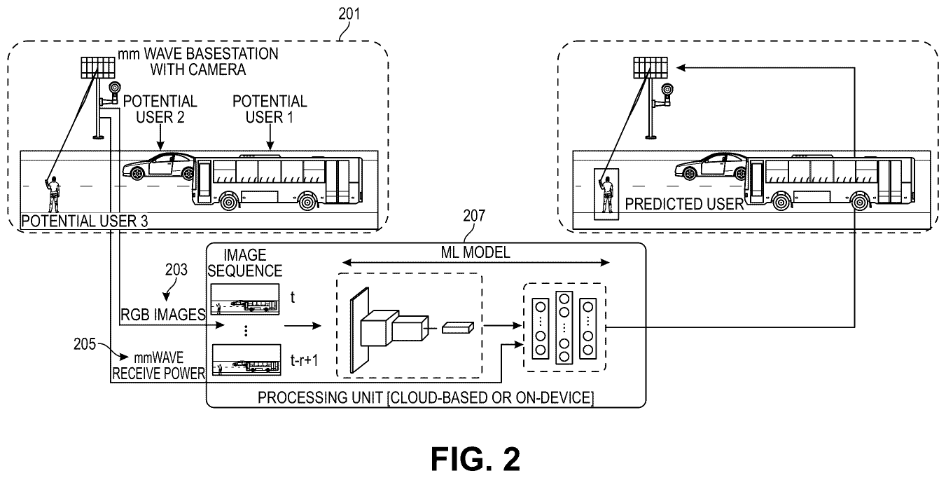

Referring now to FIG. 2, a mmWave base station 201 may serve as a mobile communication user (vehicle) in a busy environment with various moving objects such as other vehicles and pedestrians, among others. The system model may include a base station with an M-element Uniform Linear Array (ULA) and an RGB camera, operating at a mmWave frequency band. The mmWave base station 201 serves a mobile communication user (transmitter) that is equipped with a single antenna for example. In some configurations, the communication system employs, for example, Orthogonal Frequency-Division Multiplexing (OFDM) transmission with K subcarriers and a cyclic prefix of length D. In some configurations, the basestation utilizes a pre-designed beamforming codebook

$$ℱ = {\{ {f}_{q} \}}_{q = 1}^{Q} ,$$

where f_{q}∈ [symbol] ^{M×1} and Q represents the total number of beamforming vectors. hₖ[t]∈ [symbol] ^{M×1} represents the channel between the mmWave basestation and the mobile user at the k th subcarrier and time t. The basestation 201 may use the beamforming vector f_{q}∈ [symbol] to serve the communication user, and the receive signal may be represented as follows:

$${y}_{k} [ t ] = {h}_{k}^{T} [ t ] {f}_{q} [ t ] x + {n}_{k} [ t ] , \qquad ( 1 )$$

where nₖ[t] is a noise sample drawn from a complex Gaussian distribution [symbol] (0, σ²). The transmitted complex symbol x∈ [symbol] need to satisfy the following constraint [symbol] [|x|²]=P, where P is the average symbol power. The beamforming vector f*[t]∈ [symbol] at each time step t is selected to maximize the average receive SNR and is defined as

$${f}^{⋆} [ t ] = {arg max}_{{f}_{q} [ t ] ∈ ℱ} \frac{1}{K} {\sum }_{k = 1}^{K} SNR {\vert {h}_{k}^{T} [ t ] {f}_{q} [ t ] \vert}^{2} , \qquad ( 2 )$$

where SNR is the transmit signal-to-noise ratio,

$$SNR = \frac{P}{{σ}^{2}} .$$

Communication user identification is a multimodal ML task with the primary objective of identifying the communication user among the different objects present in the wireless environment. The inputs to the machine learning model are the available sensing and wireless data obtained from the environment. Identifying the communication user in the scene includes observing a sequence of RGB images 203 of the wireless environment captured by the camera installed at the base station 201, and using the sensing data along with the mmWave receive power vectors 205. The wireless channel vector h, in general, may encode more detailed information regarding the wireless environment, such as the different propagation paths between the transmitter and the receiver. The communication user identification task may operate as follows. X[t]∈ [symbol] ^{W×H×C} denotes a single RGB image 203 of the environment captured at the base station 201 at time instant t, where W, H, and C are the width, height, and the number of color channels for the image. p[t] denotes the mmWave receive power vector 205 at the base station 201. At a time τ∈ [symbol] , the base station 201 captures a sequence of RGB images 203 and the mmWave receive power vectors 205, S[τ], defined as

$$S [ τ ] = {\{ X [ t ] , p [ t ] \}}_{t = τ - r + 1}^{τ} , \qquad ( 3 )$$

where r∈ [symbol] is the length of the input sequence or the observation window to identify the user. In particular, at time t, the base station observes the sequence of data samples S[τ] to predict the bounding-box vector b_{Tx}[τ]∈ [symbol] ² corresponding to the communication user in the image samples. A function ƒ_{Θ} that maps the observed sequence of data samples, S[τ] to a prediction (estimate) of the bounding-box vector, \hat{b}_{Tx}[τ] may be used to identify the communication user. The function ƒ_{Θ} can be formally expressed as

$${f}_{Θ} : S [ τ ] \to {\hat{b}}_{T x} [ τ ] . \qquad ( 4 )$$

A ML model 207 may learn the prediction function ƒ_{Θ}. The ML model 207 takes in the observed sequence of data samples S[τ] and predicts the bounding box of the communication user

$${\hat{b}}_{T x} [ τ ] . 𝒟 = {\{ {( S , {b}_{T x} )}_{u} \}}_{u = 1}^{U}$$

represents the dataset of independent samples including sensing data bounding box vector pairs collected from the real wireless environment, where U is the total number of samples in the dataset. The prediction function is parameterized by Θ representing the model parameters. The dataset [symbol] of labeled samples is used to optimize the prediction function ƒ_{Θ} such that it maintains high fidelity for any samples drawn from this dataset. The optimization function maximizes the number of correct predictions over the samples in the dataset [symbol] , and can be calculated as

$${f}_{{Θ}^{⋆}}^{⋆} = {arg max}_{{f}_{Θ} ( . )} {\prod }_{u = 1}^{U} ℙ ( {\hat{b}}_{Tx , u} = {b}_{Tx , u} \vert {S}_{u} ) , \qquad ( 5 )$$

where the joint probability distribution in Equation (5) is due to the implicit assumption that the samples on [symbol] are drawn from an independent and identical distribution (i.i.d).

Sensing-aided communication user identification can include the following. The mmWave/sub-THz communication systems may deploy large antenna arrays and use narrow directed beams to guarantee a sufficient receive signal-to-noise ratio (SNR). The directivity of antenna arrays can be visualized as a way of concentrating the emitted radiation in a single direction. For ULAs, this directivity is achieved by the beamforming vectors in the pre-defined codebook [symbol] . The beamforming vectors can be envisioned as slicing the scene (spatial dimension) into multiple (possibly overlapping) sectors, where a sector is associated with a particular beam value. This sectoring of the wireless environment by the beamforming vectors can be extended to a visual scene. The RGB image is a projection of the 3D space onto a 2D image plane. The sectoring induced by the beamforming vectors is projected onto the 2D image plane, resulting in the form of image sectoring. The knowledge of the optimal beamforming vector or the receive power vector, in general, can be translated to directional information in an image, i.e., the direction from which the current received signal arrived. Using object detection models enables identification of different objects in the wireless environment with high fidelity in near real-time. The object detection capabilities paired with the directional information obtained from the receive power vectors together enable differentiation between the objects of interest (communication user) from the distractors in the scene. Because object detection models might result in false detection, and the communication user can be occluded in a particular instance, relying on one sample to identify the communication user can result in a wrong prediction. Identifying the communication user's approximate location in the scene can be accomplished by using the optimal beamforming or receive power vectors. At time t, by observing a sequence of r current and previous samples, the effect of non-ideal sectoring and the probability of missed detection can be reduced.

Identifying communication users within a multi-candidate, wireless setting includes using visual and wireless data from the dataset [symbol] to identify the communication user 209 in the scene accurately. To identify the communication user using a single data sample, (1) Deep Neural Networks (DNNs) may be used to generate bounding boxes that encapsulate different objects present in the scene, (2) a DNN may use wireless data to predict the likely centers of the communication user's bounding boxes, and (3) detected candidates that are not the radio transmitter/receiver may be filtered out. A comprehensive explanation of the three-step DNN structure is presented in the following paragraphs.

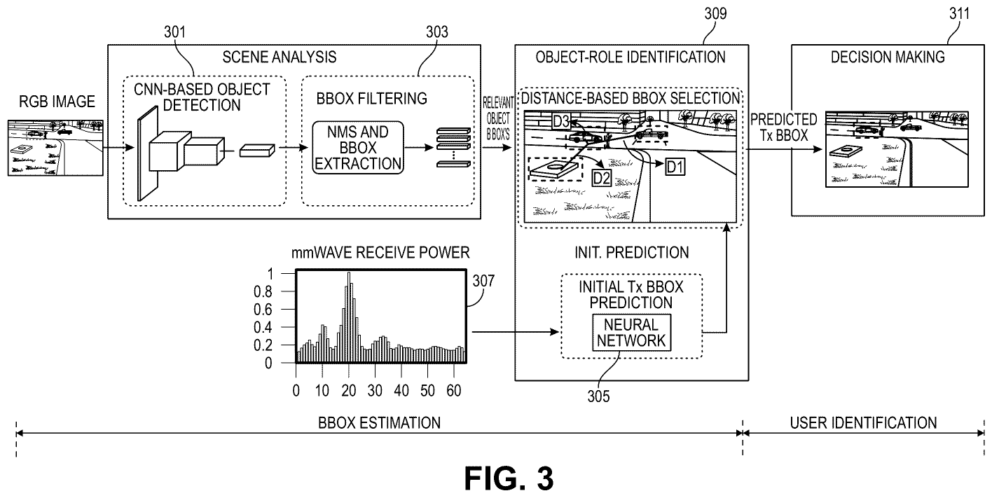

Referring now to FIG. 3, a depiction of a communication user identification solution based on a single data sample is shown. In some configurations, to perform communication user identification in wireless environments, the first step may involve identifying the relevant objects of interest within the scene, a process termed “scene analysis.” For example, in a scene depicting a city street, relevant objects include but are not limited to, cars, trucks, buses, pedestrians, and cyclists. A pre-trained object detector 301, such as, for example, but not limited to, COCO pre-trained YOLOv3, may detect bounding boxes at a relatively high frame rate, thereby reducing inference latency. To train and assess the communication user identification solution, the bounding-box coordinates (ground truth) of the communication user within the scene are accessed. Information specifying which object is the communication user can be determined by annotation and fine-tuning of the pretrained object detection model. The object detection model is fine-tuned to identify two classes of objects within the scene, labeled as communication user and distractor. To fine-tune the object detection model, a subset of the dataset is annotated to label relevant objects, where the radio transmitter/receiver is tagged as communication user and other relevant objects as distractor. The modified object detector is fine-tuned in a supervised manner using the labeled dataset. The refined object detection model 303 may be used to generate the bounding-box coordinates of the remaining samples in the dataset. A verification process ensures the accuracy of the generated bounding boxes. During inference, the fine-tuned YOLOv3 model generates bounding boxes for the detected candidates in the scene and their confidence scores. The output bounding boxes are then utilized to construct the relevant-object matrix B∈ [symbol] ^{N×2} such that a row contains the normalized coordinates of the center of a bounding box, with N representing the number of relevant objects in the scene.

The centers of the bounding boxes are found by using both the relevant-object matrix B and the wireless receive power vector to predict the bounding box center coordinates of the communication user. The process includes learning a prediction function that estimates the bounding box center coordinates of the communication user using the receive power vector. The relationship between the receive power vector and the object's location in the image are encoded. This mapping may be accomplished through the deployment of a 2-layered feed-forward neural network 305 (designed to perform a regression task). The model predicts continuous outputs, specifically the spatial coordinates of a communication user's bounding box center. The network includes two dense layers with a configurable number of neurons and utilizes ReLU activation functions to introduce non-linearities. This structure allows the model to learn and capture complex patterns between the received signal data and the communication user's location within the image. The function is denoted as

$${f}_{Θ2} : r [ t ] \to {\hat{b}}_{T x} [ t ] \qquad ( 6 )$$

where \hat{b}_{Tx}[t]∈ [symbol] ^{2×1} is a vector with an initial prediction of the centers of the user and the r[t]∈ [symbol] ^{Q×1} is the mmWave receive power vector at any time instant t. Let

$${𝒟}_{2} = {\{ {( r , {b}_{T x} )}_{u} \}}_{u = 1}^{U} and {𝒟}_{2} ⊂ 𝒟$$

be a dataset comprising of the mmWave receive power vectors and the ground-truth bounding box center coordinates of the user. The prediction function ƒ_{Θ2} is parameterized by a set Θ₂, which represents the model parameters and is learned from the dataset [symbol] ₂ of the labeled data samples. \hat{b}_{Tx} is an initial estimate relying on the receive power vector 307 that forms an approximation. The approximate prediction is used in conjunction with the relevant-object matrix B to identify 309 (or select) the object that is the source of the radio signal.

To select a bounding box, the following process is followed. The relevant-object matrix B includes the bounding box coordinates of the objects of interest (probable communication users) in the wireless environment. An additional modality, for example, but not limited to, the wireless receive power vector, is used to predict the approximate center coordinates of the communication user in the scene. The bounding box coordinates and the approximate center coordinates are used to identify the communication user within the scene. The identification process 311 is performed using the nearest neighbor algorithm with a Euclidean distance metric. The Euclidean distance between the predicted center coordinates and the objects in B is computed. The object in B with the shortest distance to \hat{b}_{Tx} is selected as the nearest neighbor, and identified as the predicted communication user object.

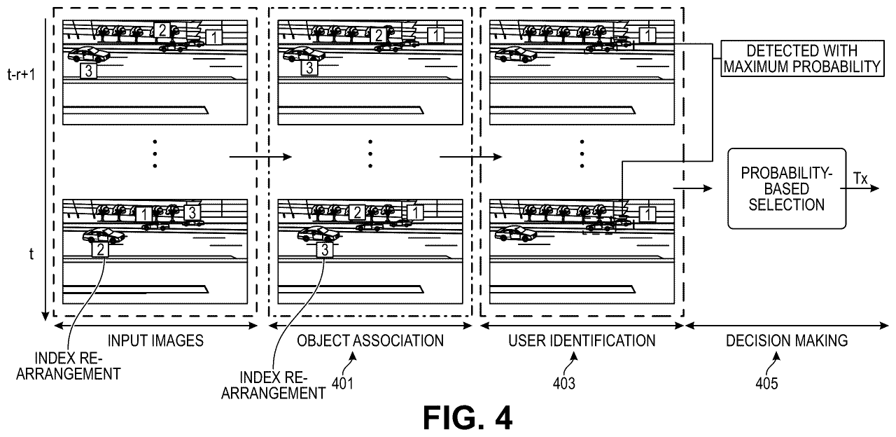

Referring now to FIG. 4, a sequence of operations of a communication user identification model where the sequence uses visual and wireless data to predict the communication user in the scene is shown. The sequence includes (i) object association-based tracking 401, (ii) communication user identification 403, and (iii) maximum probability-based identification 405. To extend the communication user identification from one sample to a sequence of samples, the process observes a sequence of r data samples and tracks the relevant objects through time, in addition to identifying which of these objects is the communication user in the scene. Sequence-based communication user identification includes object association-based tracking, communication user identification, and maximum probability-based identification.

Object association-based tracking 401 may involve vehicle-to-infrastructure communication, with mobile vehicles serving as the primary objects of interest. Object association-based tracking employs a sequence of images, assigns an identification (ID) to a detected object, and maintains that ID for as long as the object remains visible in the sequence of images. In some configurations, a distance-based tracking algorithm is used to perform object association-based tracking. For example, a Euclidean distance-based measurement technique, similar to the bounding box selection step described herein, is used. The object association-based tracking process detects objects of interest across r image samples in the sequence and extracts the bounding box center coordinates. For example, N1 and N2 objects are detected in the first and second image of the sequence with different objects labeled from 1, . . . , N1 for the first image and labeled 1, . . . , N2 for the second image. There could be the same number of objects in two consecutive image samples, i.e., N1=N2, or there could be a different number of objects, i.e., either N1>N2 or N1<N2. The Euclidean distance between the detected objects in the first image and the objects in the second image is computed. The objects in the second image are re-numbered based on the calculated distance. For example, if the third object in the first image has the shortest Euclidean distance with the first detected object in the second image, the third object is re-numbered as “3”. For two consecutive image samples, the distance between the bounding box center coordinates will be the least for the same object compared to other objects in the scene.

The communication user is identified for the r data samples in the sequence by the \hat{N}∈ [symbol] ¹ denoting the index of the communication user in the scene, as described herein for single sample communication user identification. Computing the maximum probability-based identification for the sequence-based solution includes the following steps. The vector of r indices, i.e., {\hat{N}₁, . . . , \hat{N}ᵣ} are obtained by performing object association-based tracking 401 and communication user identification 403. The object that has been identified as the communication user most often across the r data samples is finally identified 405 as the communication user in the scene.

In some configurations, a real-world multimodal dataset designed to facilitate the development of sensing-aided wireless communication applications such as, for example, but not limited to, the DeepSense 6G dataset, is used to evaluate the sensing-assisted communication user identification as described herein. The DeepSense 6G dataset includes co-existing multimodal data, including vision, mmWave wireless communication, GPS data, LiDAR, and radar, collected in a wireless environment. Scenarios are described herein that are designed to explore high-frequency wireless communication applications in a multi-candidate setting. To collect data for the scenarios, a testbed includes a stationary unit (serving as the base station) and a mobile transmitter (a vehicle). The stationary unit unit1 (RX) is equipped with an RGB camera and a mmWave Phased array. This unit deploys a 16-element (M=16) phased array operating in the 60 GHz-band and receives the transmitted signal utilizing an over-sampled codebook of 64 pre-defined beams (Q=64). The mmWave phased array and the RGB camera are positioned such that their fields of view align. As for the mobile unit, unit2 (TX), it is a vehicle equipped with a quasi-omni antenna, transmitting (omnidirectional) in the 60 GHz band and a GPS antenna/receiver to collect the real-time position of the communication user. Data are captured at a frequency of ≈10 Hz on the base station side. Collected sensor data include an RGB image of the wireless environment, and a 64-element mmWave receive power vector.

Test and training scenarios include diverse data collected at different locations and during different times of the day (day and night). At time t, a multimodal scenario dataset comprises an RGB image, X[t], the corresponding receive power vector r[t], and the communication user position. The ground-truth bounding box center coordinates of the communication user (transmitter) in the scene, b_{TX}[t] are generated and labeled. Data from a development dataset of the communication user identification prediction task are processed using a sliding window to generate a time-series dataset including input data images and corresponding mmWave receive power. The dataset is divided into training and test sets following a 70-30% split. In Table 1, the details of the development datasets for the sensing-aided communication user identification task are listed. To evaluate the efficacy of the proposed sensing-aided communication user-identification solution, the development datasets of two scenarios are used. The model is trained and tested on the development dataset of the scenarios. The model is trained with the labeled dataset of one of the scenarios and tested on the dataset of the other scenario. To analyze the model's ability to adapt to unseen dataset, a development dataset of another scenario is used. It involves training the proposed machine learning-based model on the development dataset of the first two scenarios and testing on the third scenario dataset.

TABLE 1
Number of data sequences in the development dataset.

| | Number of Sequences | |
|---|---|---|
| Number | First scenario | Second Scenario |

| of Objects | Training | Validation | Training | Validation |
|---|---|---|---|---|
| 1 | 376 | 140 | 417 | 187 |
| 2 | 291 | 86 | 325 | 140 |
| 3 | 140 | 46 | 182 | 79 |
| 4 | 61 | 28 | 83 | 30 |
| 5 | 32 | 12 | 27 | 12 |
| 6 | 6 | 7 | 6 | 9 |
| 7 | 0 | 3 | 7 | 0 |

For bounding box center prediction, the mmWave receive power vectors are provided as input to the feed-forward neural network to predict the approximate bounding box center coordinates of the communication user. The two-layered feed-forward neural network is trained using the labeled development dataset discussed herein, employing a cross-entropy loss function and an iterative optimization process that is used to minimize the loss function during the training of neural networks. An optimization process is the adaptive moment estimation (Adam) process. Exemplary simulations are conducted on a single NVIDIA Quadro 6000 GPU leveraging the PyTorch deep learning framework. Design and training hyper-parameters are provided in Table 2.

TABLE 2
Design and training hyper-parameters.

| Parameters | MLP |
|---|---|
| Batch Size | 32 |
| Learning Rate | 1 × 10⁻³ |
| Learning Rate Decay | epochs 80 and 120 |
| Learning Rate Reduction Factor | 0.1 |
| Dropout | 0.3 |
| Total Training Epochs | 50 |

A method of evaluating the processes described herein is through a top-1 accuracy metric defined as:

$$A c {c}_{top - 1} = \frac{1}{U} {\sum }_{u = 1}^{U} 𝟙 \{ {\hat{b}}_{T X , u} [ τ ] = {b}_{TX , u} [ τ ] \} , \qquad ( 7 )$$

where \hat{b}_{Tx,u}[τ] and b_{Tx,u}[τ] are the predicted and groundtruth bounding box center coordinates, respectively. U is the total number of samples present in the validation/test set. [symbol] {⋅} is the indicator function.

The evaluation of the sensing-aided communication user identification described herein includes evaluating the single sample-based communication user identification process on the development dataset of both scenarios described herein. The model that enables the process is trained and tested in both scenarios. A desired communication user identification accuracy may be obtained by using approximately 30% of the total training samples. For example, a machine learning model may learn the communication user identification task with roughly 270 samples for the first scenario and approximately 310 samples for the second scenario.

The performance of the process described herein with a machine learning solution may be based on a Random Forest algorithm. The evaluation may use data collected in complex and variable conditions with multiple potential communication users. The neural network-based process described herein for the first scenario performs similarly to a Random Forest algorithm process. In the second scenario, the neural network-based process outperforms the Random Forest approach. A pre-trained YOLOv3 object detection model used to identify objects and predict their bounding box coordinates has a mean average precision (mAP) of approximately 60%, which is further amplified under nighttime conditions, as experienced in the second scenario.

To evaluate the effect of sequence data, a time-series dataset with a window length of 3 and 5 for both the scenarios is used. A single sample-based solution is extended to a sequence-based communication user identification solution. The communication user identification accuracy versus the input sequence length is presented for both scenarios.

Evaluation of the time efficiency and computational demands of the communication user identification system is shown in Table 3.

TABLE 3
Time and computational complexity of the proposed approaches.

| | | Latency | Total |
|---|---|---|---|
| Approach | Steps | (ms) | Parameters |
| Single- | Bounding-box detection | 30 | ≈63M |
| sample | Bounding-box center prediction | 0.376 | 559105 |
| | User identification | 0.0217 | 0 |
| | Total | 30.3977 | ≈63.5M |
| Sequence- | Bounding-box detection | 30 | ≈63M |
| based | Object association-based tracking | 0.012 | 0 |
| | Bounding-box center prediction + | 0.3977 | 559105 |
| | User identification | | |
| | Maximum probability-based | 0.01 | 0 |
| | identification | | |
| | Total | 30.4197 | ≈63.5M |

The single-sample method processes an action within 30.3977 milliseconds and operates with close to 63.5 million parameters. The most time-consuming task in this method is the detection of bounding boxes, accounting for the processing time. The inference times for these machine learning models were computed on an Nvidia Quadro RTX 6000 GPU. In comparison, the sequence-based approach records a slight increase in total processing time to 30.4197 milliseconds, while maintaining the same parameter count. The incremental rise in time is attributed to the sequence-based method's additional steps. Other object detection models can be used such as, for example, but not limited to, SqueezeDet and EfficientDet-D0.

The distance-based tracking algorithm in the context of vehicle-to-infrastructure communication is evaluated by assigning and maintaining object IDs within an image sequence. To measure the accuracy of object association, the ground-truth bounding box of the communication user (transmitter) in the scene is used. The IDs assigned to the communication user across the samples in a sequence are used. A correct association is identified when the communication user has been assigned the same ID across samples. The process described herein achieves high object association accuracy across both scenarios, irrespective of the sequence length.

The model is tested for its ability to generalize across different data distributions. An inter-scenario experiment is used to train the model on the training dataset of one scenario and evaluate the performance on the test dataset of another scenario. For example, the first and second scenarios are used for the experiment. The scenarios belong to the same location, and the data samples were collected during different times of the day. The situation in which the model is trained and tested on the same dataset is compared to the situation in which the model is trained on one scenario and evaluated on different scenario test data.

Scenarios collected at different locations and at different times of the day can be used evaluate whether the system can adapt to an unseen location with few or no labeled data samples. Scenarios, for example, including streets with different numbers of lanes and different distances from the base station can be used. Such differences result in variations in the distribution of the mmWave receive power. The communication user identification accuracy when the ML model is trained and tested on a first scenario dataset may be compared with the communication user identification accuracy when the ML model is trained on a first scenario dataset and evaluated using a second scenario dataset. The system can identify the communication users under the different evaluation situations.

To consider the impact of vehicle speed on the communication user identification accuracy, the position of the communication user is used to estimate a communication user speed by considering the difference between the initial and final position in a sequence, and calculating the speed mean and standard deviation. Communication users may be classified as slow-moving, fast-moving, and average speed, based on the communication user speed, mean speed, and standard deviation. The communication user identification accuracy versus the vehicle speed is presented in which the difference in accuracy between the slow and fast moving communication user is small.

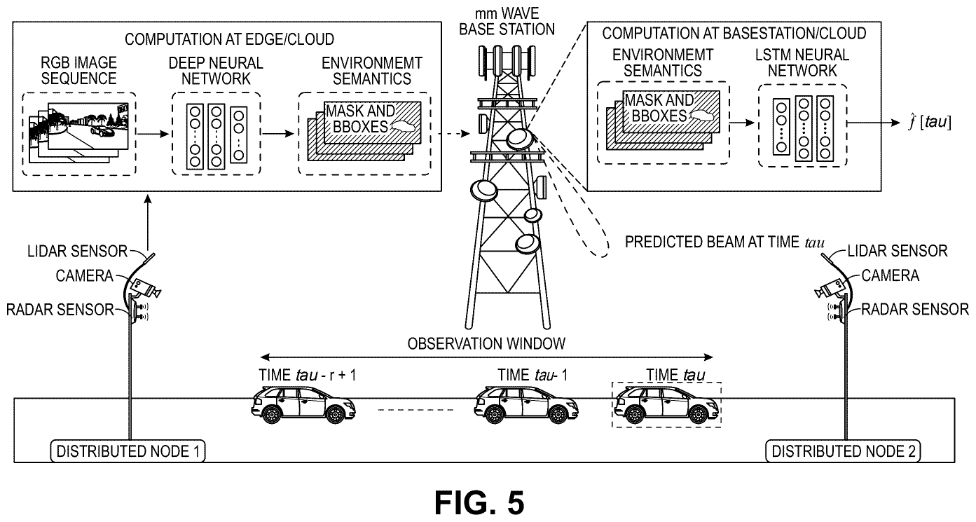

Referring now to FIG. 5, illustrated is a distributed sensing-aided communication system in which N distributed nodes sense the environment and transmit environment semantic information to a base station that is serving a mobile communication user. Distributed nodes in the system are equipped with an RGB camera, and the base station is equipped with an RGB camera and 3 M-element uniform linear arrays (ULAs) having a field of view of around 90°. The three ULAs are positioned 90° apart from each other and oriented towards the front, left, and right of the base station. The area served by the base station is divided into N+1 subregions. The base station camera provides sensing information for the region directly in front of the base station while distributed nodes provide sensing information for the remaining N regions. The distributed nodes are positioned to provide the combined camera coverage over the range of the mmWave communication system. The communication user (referred to herein as the transmitter) is equipped with a single-antenna transmitter and a GPS receiver for collecting real-time position information.

The basestation, for each ULA, uses (i) OFDM transmission with K subcarriers and a cyclic prefix of length D, and (ii) a pre-defined beam steering codebook

$$ℱ = {\{ {f}_{q} \}}_{q = 1}^{Q} ,$$

where f_{q}∈ [symbol] ^{M×1} is the q^{th} beamforming vector and Q is the total number of beamforming vectors. The beam steering beams are uniformly spaced and jointly cover the ULA's 90° field of view. In the downlink, the received signal at the user from the ULA that has the user in its field of view at the k^{th} sub-carrier and time t can be represented as

$${y}_{k} [ t ] = {h}_{k}^{T} [ t ] {f}_{q} [ t ] x + {v}_{k} [ t ] \qquad ( 8 )$$

where hₖ[t]∈ [symbol] ^{M×1} denotes the channel between the basestation and the mobile user, f_{q}∈ [symbol] is the beamforming vector, and vₖ[t] represents noise sampled from a complex Gaussian distribution [symbol] (0, σ²). The transmitted complex symbol x∈ [symbol] satisfies the power constraint [symbol] [|x|²]=P, where P is the average symbol power. Moreover, the beamforming vector f_{q}[t], at each time step t is selected from the beam steering codebook [symbol] to maximize the average receive SNR as follows

$${argmax}_{{f}_{q} [ t ] ∈ ℱ} \frac{1}{K} {\sum }_{k = 1}^{K} S N R {\vert {h}_{k}^{T} [ t ] {f}_{q} [ t ] \vert}^{2} , \qquad ( 9 )$$

where SNR is the transmit signal-to-noise ratio,

$$S N R = \frac{P}{{σ}^{2}} .$$

At any time instant t, the receive power vector of effective channel gain with codebook elements from the ULA that has the user in its field of view can therefore be expressed as p[t]=[p₁[t], . . . , p_{Q}[t]], where p[t]∈ [symbol] ^{Q×1} and p_{q}[t] is defined as

$${p}_{q} [ t ] = {\vert {h}_{k}^{T} [ t ] {f}_{q} [ t ] \vert}^{2} \cdot q ∈ 1 , … , Q \qquad ( 10 )$$

The distributed environment semantic-aided beam prediction system is used to select the optimal beam index (at the base station for time t) that maximizes the receive power using camera images captured by the distributed node. The system determines the ULA that encompasses the communication user within its field of view, identifies the sub-region where the communication user is located, and discerns the transmitter vehicle from other vehicles present in the RGB images. The beam prediction model uses a sequence of available RGB images and the ground truth receive power vector corresponding to the time of the first image capture. The receive power vector corresponding to the first image capture in the sequence is used to identify the ULA and the sub-region where the communication user is located, and facilitates the identification of the transmitter in the scene. Xₙ[t]∈ [symbol] ^{W×H×C} represents the RGB image captured at time t by the camera installed at the nth node, where W, H, and C are the width, height, and the number of color channels for the image, respectively. p[t]∈ [symbol] ^{1×Q} denotes the mmWave receive power vector from the ULA that has the communication user in its field of view at time t. At time t, the distributed node n, captures a sequence of r RGB images, and the base station collects the mmWave receive power vector corresponding to the time t of the first image capture, S[t], defined as

$$S [ t ] = \{ {\{ {X}_{n} [ t ] \}}_{t = τ - r + 1}^{t = τ} , p [ τ - r + 1 ] \} \qquad ( 11 )$$

where r∈ [symbol] is the length of the input sequence or the observation window to predict the optimal beam index. At time t, a mapping function ƒ_{Θ} that utilizes the available sensory data samples S[t] to predict (estimate) the optimal beam index \hat{f}[t]∈ [symbol] with high fidelity. The mapping function can be formally expressed as

$${f}_{Θ} : S [ t ] \to \hat{f} [ t ] . \qquad ( 12 )$$

$$𝒟 = {\{ ( {S}_{l} , {f}_{l}^{⋆} ) \}}_{l = 1}^{l = {1}_{}}$$

represents the available dataset collected from the real-world wireless environment. The total number of samples in the dataset is denoted by ϰ₁. The goal is to maximize the number of correct predictions over all the samples in the dataset [symbol] . This can be formally written as:

$${f}_{{θ}^{⋆}}^{⋆} = {argmax}_{{f}_{θ}} {\prod }_{l = 1}^{{1}_{}} ℙ ( {\hat{f}}_{l} = {f}_{l}^{⋆} \vert {S}_{l} ) , \qquad ( 13 )$$

where the joint probability distribution in (13) is due to the implicit assumption that the samples in [symbol] are drawn from an independent and identical distribution. The objective is to find the optimal set of parameters Θ* that maximizes the product of the probabilities of correct predictions.

The system sets up distributed nodes and uses the environment semantics from the distributed nodes for beam prediction at the base station. Various sensing modalities including position (GPS location), LiDAR, radar, and RGB images can be used for beam prediction. The system uses mmWave communication to handle both LOS and NLOS cases, and a distributed sensing approach is used. This distributed sensing approach uses multiple distributed nodes equipped with sensors such as camera, LiDAR, and radar. By distributing the sensors, the limitations in range are overcome and the scope of data collection is expanded. NLOS scenarios are handled by enhancing sensing coverage and capturing diverse perspectives. As the number of distributed nodes increases, there is a corresponding increase in the volume of captured data, and a heightened data rate. The traffic volume between the base station and the distributed nodes can be reduced by selectively transferring information. For example, in the case of a distributed node equipped with a camera, the environment semantics can be extracted locally. Environment semantics include relevant information about the wireless environment, such as the presence of different vehicles in the scene and their relative locations. The system extracts environment semantics, identifies the transmitter in the scene, and predicts the optimal beam in real time, and can predict future beams to address transmission latency.

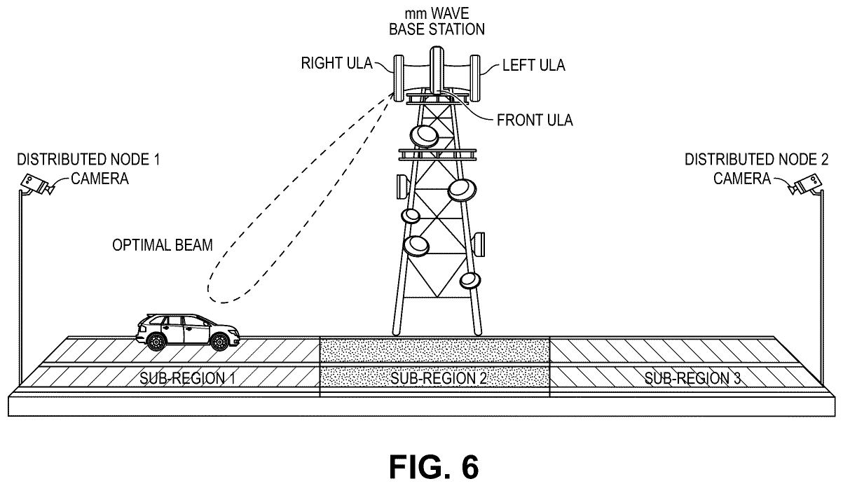

Referring now to FIG. 6, the region served by the base station is divided into a pre-selected number of sub-regions, for example, three sub-regions that correspond to the phased arrays of the base station. One distributed node is located to the left of the base station and the other to the right, for example. At time t, the selection of sensing data for further processing and beam prediction depends on the communication user's location in the wireless environment. For example, if the communication user is situated in the sub-region to the right of the base station, the RGB images captured by the right distributed node (distributed node 1) are utilized for beam prediction. The selection of the distributed node for further processing and beam prediction does not rely on the communication user's position data (GPS position). The receive power vector provides directional information that aids in determining the optimal beam index. One of the ULAs is selected by using the optimal beam index. Depending on the selected ULA, the sub-region where the communication user is located is approximated, which helps identify the distributed node from which to utilize the sensing data.

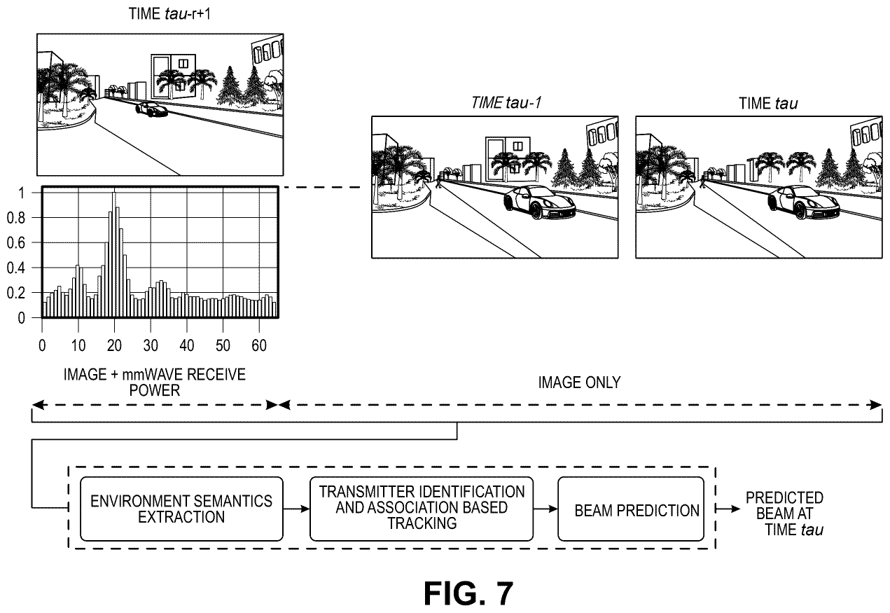

Referring now to FIG. 7, environment semantics are extracted, using a machine learning model to extract object masks and bounding boxes of communication users, shown here as mobile vehicles communicating by vehicle-to-infrastructure communication. The receive power vector identifies and tracks the transmitter over the subsequent r−1 frames using the nearest neighbor algorithm, for example. Semantic information, such as the color of vehicles, can be used to improve the accuracy of object association-based tracking. The base station predicts the optimal beam index based on the transmitter's semantic information from the current and past r frames.

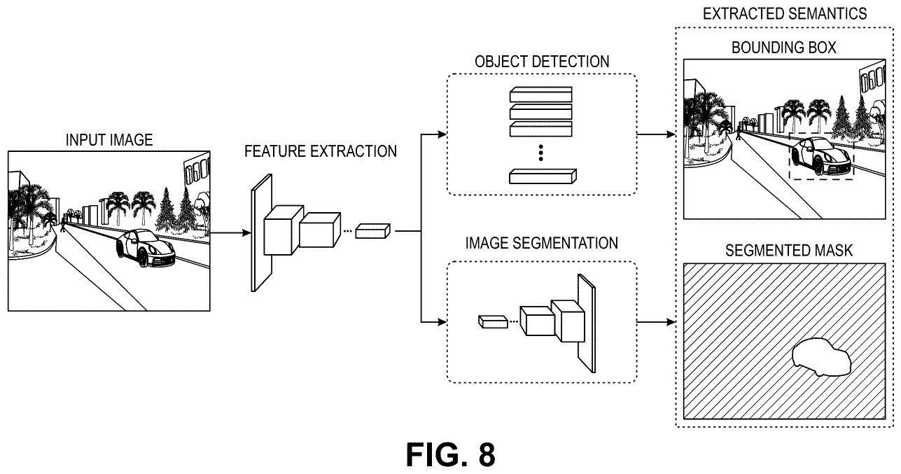

Referring now to FIG. 8, to extract environment semantics from RGB images, information that represents the objects of interest in the wireless environment is captured, data storage is minimized to the original sensing modality (for example, the images themselves). An exemplary object detection model includes the COCO pre-trained object detection and image segmentation model, YOLOv7. Bounding boxes and binary masks are determined from the object detection model. Bounding boxes are denoted herein as X_{BBox}[t]∈ [symbol] ^{U×4}, and serve as representations for communication users within the wireless environment, where U is the number of detected objects in the RGB image. A row of X_{BBox}[t] includes a bounding box vector [xc, yc, w, h], where xc, yc, w, and h denote the x-center, y-center, width, and height of the detected object, respectively. The bounding boxes provide spatial information about the communication users. Binary masks, represented as X_{Mask}[t]∈ [symbol] ^{Ŵ×Ĥ}, where Ŵ and Ĥ correspond to the downsampled width and height of the image mask, respectively. The binary masks are detailed and fine-grained depictions of the spatial extent of the communication users within the wireless environment. An image segmentation model outputs the binary masks and provides the bounding box information for the detected objects. X_{B-Mask} [t]∈ [symbol] ^{U×4} denotes the bounding boxes extracted during the image segmentation.

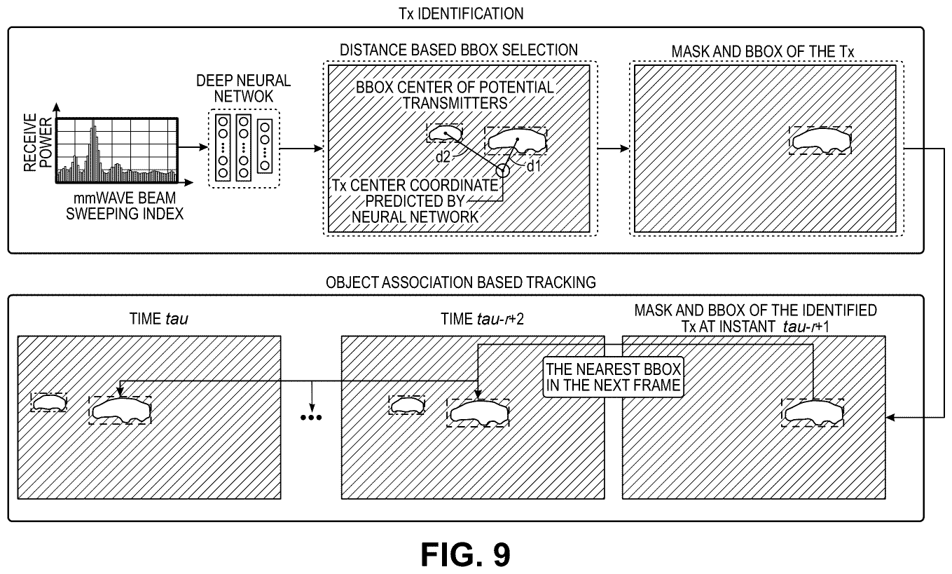

Referring now to FIG. 9, to predict the optimal beam index, the transmitter in the RGB image is identified from the detected objects and tracked over the subsequent r−1 samples. Determining the transmitter's location within the wireless environment includes using the extracted semantic information, such as bounding boxes and masks. The image segmentation model provides binary masks and bounding box information for the detected objects. The system uses the receive power vector p[τ−r+1] from the ULA that has the communication user in its field of view and the semantic information of masks and bounding boxes at time t=τ−r+1 to predict the center coordinates of the transmitter's bounding box b_{Tx}[τ−r+1]∈ [symbol] ^{2×1} within the image. A prediction function g_{η}, is used, parameterized by a set of parameters η, which maps the receive power vector to the predicted bounding box center coordinates \hat{b}_{Tx}. Mathematically, this can be expressed as:

$${g}_{η} : p [ t ] \to \hat{{b}_{Tx}} [ t ] . \qquad ( 14 )$$

To train the prediction function, a dataset [symbol] ₂ including pairs of mmWave receive power vectors pᵥ and their corresponding ground-truth bounding box center coordinates of the transmitter bTxv are used. This dataset, [symbol] ₂, is a subset of a larger dataset [symbol] , and includes V samples, such that

$${𝒟}_{2} = {\{ ( {p}_{v} , {b}_{Txv} ) \}}_{v = 1}^{V}$$

The system minimizes the error between the predicted and ground-truth center coordinates of the transmitter's bounding box across the samples in [symbol] ₂. This optimization problem can be formulated as:

$${g}_{{η}^{⋆}}^{⋆} = {argmin}_{{g}_{η}} \frac{1}{V} {\sum }_{v = 1}^{V} {‖ {\hat{b}}_{Txv} - {b}_{Txv} ‖}^{2} , \qquad ( 15 )$$

where

$${g}_{{η}^{⋆}}^{⋆}$$

represents the optimal prediction function that minimizes the squared l₂ norm of the error between the predicted and ground-truth bounding box center coordinates. By training the prediction function gη on the dataset D2, the transmitter's location is identified within the wireless environment based on the extracted semantic information and the receive power vector from the ULA that has the communication user in its field of view. To learn g_{η}, a two-layered fully connected neural network with 512 nodes in each layer is used, for example. The obtained b_{Tx} from g_{η} is an initial estimate based on wireless data. The initial estimate together with the semantic information at time t is used to identify the bounding box and mask of the object responsible for the received signal. The bounding box of the transmitter is identified by locating the bounding box in X_{BBox} [τ−r+1] and X_{B-Mask} [τ−r+1] whose center coordinate is closest to \hat{b}_{Tx}[τ−r+1]. The prediction function g_{η} approximates the center coordinates near the actual values, and the Euclidean distance-based metric can identify the transmitter. The system assumes that there is a transmitter present in the wireless environment at time t.

Continuing to refer to FIG. 9, tracking the bounding box and mask of the transmitter for the next r−1 samples captures the transmitter's movements. Transmitter tracking can include different processes for the different environment semantics. A first process is Bbox-based object tracking, and a second process is mask-based object tracking. Bbox-based object tracking includes, for example, but not limited to, Euclidean distance-based object association process which determines the transmitter in the next sample by finding the bounding box in XBBox (of the following sample) with the closest center coordinate to the bounding box in the current sample. For two consecutive image samples, the distance between the center coordinates of the bounding box is the smallest for the same object compared to other objects in the scene. Mask-based object tracking includes using masks such as, for example, but not limited to, the median color value of mobile vehicles. Using binary masks, the color information of the detected vehicles is extracted at the distributed nodes by performing a Hadamard product between the binary mask and the RGB image, followed by calculating the mean value of the pixels where the binary mask contains a 1. The color information, binary masks, and bounding boxes are used to improve the object association-based tracking accuracy following identifying the transmitter. For example, vehicles whose color does not match that of the transmitter identified in the first sample are filtered out. ρ∈ [symbol] ³ denotes the median RGB color value of a candidate. ρ_{Tx} and ρ_{z} represent the median RGB color values of the transmitter and the z^{th} communication user in the mask, respectively. The communication user is considered a candidate for subsequent object association if criteria such as the following are satisfied:

$${‖ {ρ}_{Tx} - {ρ}_{z} ‖}_{F} \leq \qquad ( 16 )$$

where ϵ is a tunable threshold. The decision of which candidate is retained in the list of communication users depends on the choice of EE, for example, but not limited to, the value of 20. The filtering that utilizes color information is referred to herein as “semantic-aided filtering”. To identify the transmitter's mask in a subsequent sample, the mask of the vehicle with the shortest distance to the transmitter's mask in the previous frame is chosen as the nearest neighbor. The selected mask is designated as the transmitter's mask in the subsequent frame.

The system uses the sequence of bounding-box coordinates or image masks obtained from the object association-based tracking to make a beam prediction for the optimal beam index. The beam prediction can be made by using a single instance-based beam prediction process or a sequence-based beam prediction process. In the single instance-based process, the bounding box or mask at time t is used to predict the optimal beams. For the sequence-based process, the sequence of r available environment semantics is used to make the prediction.

Bounding box-based beam prediction includes a mapping function that takes the communication user's bounding box at time t as input and predicts the corresponding beam index.

$$ω : {x}_{bbox} [ t ] \to \hat{f} [ t ] \qquad ( 17 )$$

where ω represents the mapping function and x_{bbox}[t]∈ [symbol] ^{2×1} represents the center coordinate of the transmitter vehicle's bounding box at time t. The mapping function is, for example, a two-layered fully connected neural network with 512 neurons in each layer. Fully connected neural networks (FCNNs) handle structured data by using network weights to capture the relationships among input elements. FCNNs establish connections between adjacent layers, enabling them to learn associations between input elements. The FCNN model receives the bounding box coordinates as the input and is trained on a labeled dataset to predict the optimal beam index.

Mask-based beam prediction, similar to bounding box-based beam prediction, includes a mapping function that takes the transmitter vehicle's mask at time t as input and predicts the corresponding beam index as

$$β : {x}_{mask} [ t ] \to \hat{f} [ t ] , \qquad ( 18 )$$

where β represents the mapping function for this task and xₘₐₛₖ[t]∈ [symbol] ^{Ŵ×Ĥ} represents the transmitter vehicle's mask at time t. Convolutional neural networks (CNNs) use spatial relationships among neighboring pixels in image data. The mapping function β for a mask-based beam prediction process is a CNN model, for example, but not limited to, a LeNet model, which includes two convolutional layers followed by two fully connected layers. Taking the mask as input, the LeNet model is trained to predict the optimal beam indices.

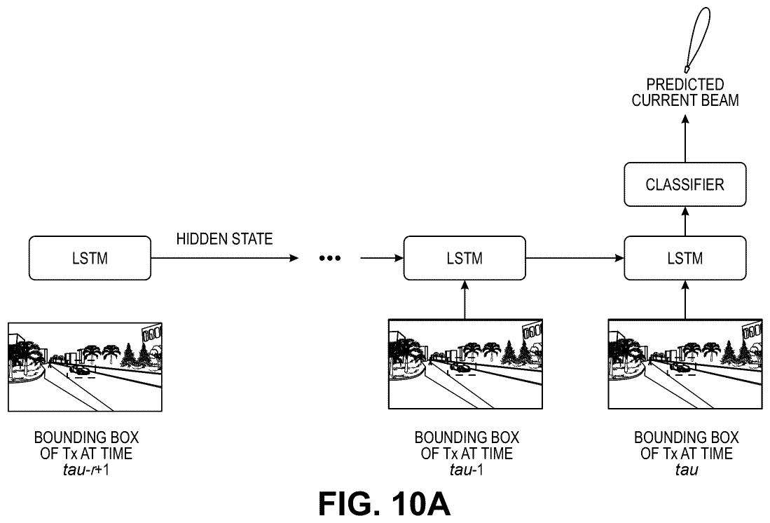

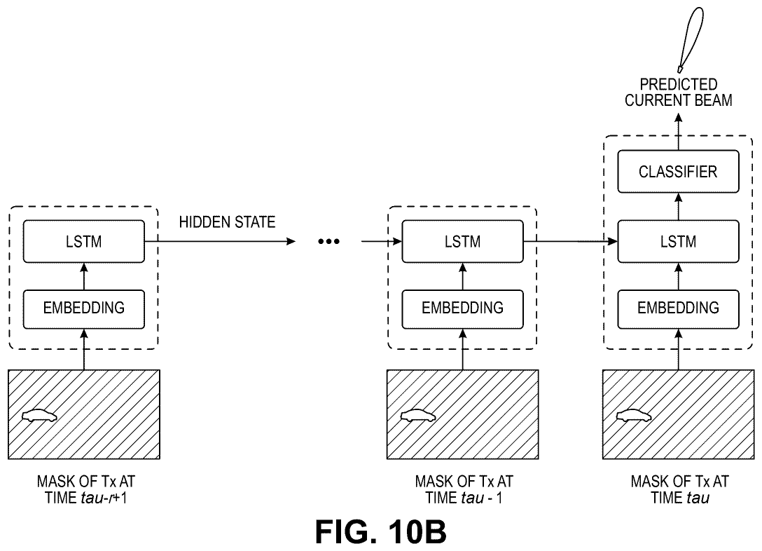

Referring now to FIGS. 10A and 10B, in sequence-based beam prediction, a recurrent neural network (RNN) is used to process a sequence of semantic representations of the transmitter and predict the optimal beam index as the output. RNNs can extract information from previous sensory data, allowing the model to capture the temporal dependencies and patterns in the semantic information. By considering the historical sequence of transmitter representations, the RNN model can learn the correlations between the semantic information and the optimal beam selection. For sequence based beam prediction with bounding boxes as inputs, a mapping function takes a sequence of the transmitter vehicle's bounding boxes over r consecutive time stamps and predicts the corresponding beam index at the last time step.

$$γ : {\{ {x}_{bbox} [ t ] \}}_{t = τ - r + 1}^{t = τ} \to \hat{f} [ τ ] , \qquad ( 19 )$$

where γ represents the mapping function for bounding box sequence-based beam prediction. The mapping function γ takes the shape of a RNN model. In FIG. 10A, the RNN model for beam prediction is shown using bounding boxes as inputs. This model includes r repeated blocks, each including a Long Short-Term Memory (LSTM) unit. The bounding box vectors are directly fed into the LSTM block. The hidden state of the LSTM is initialized with zero vectors. The model classifier uses a cross-entropy activation function. The output of the classifier is a score vector. The beam index with the highest score is the predicted optimal beam.

In mask-based beam prediction, similar to bounding box sequence based-beam prediction, a mapping function is used that takes a sequence of the transmitter vehicle masks over r consecutive time stamps and predicts the beam index at the last time step.

$$ψ : {\{ {x}_{mask} [ t ] \}}_{t = τ - r + 1}^{t = τ} \to \hat{f} [ τ ] , \qquad ( 20 )$$

where ψ represents the mapping function that takes the shape of a RNN as shown in FIG. 10B. The model includes r repeated blocks including LSTM units. Due to the structural differences between masks and bounding box vectors in terms of semantic representation, an embedding block is included in this model. The embedding block uses the LeNet model, including two convolutional layers and two fully connected layers. The output layer of the LeNet model is removed, and the output from the prefinal layer is used as input to the LSTM model. The LSTM model transforms the high-dimensional semantic mask xₘₐₛₖ[t] into a low-dimensional embedded vector x[t]∈ [symbol] ^{v×1}, where v represents the hidden state size of the LSTM. The LSTM hidden state is initialized with zero vectors. The remaining components, including the LSTM blocks and the classifier with the cross-entropy activation function, are similar to the bounding box-based model. The model predicts the optimal beam index based on the scores obtained from the classifier.

In the position-aided transmitter identification approach, a machine-learning model predicts the center coordinate of the transmitter's bounding box based on its GPS position. The network architecture for position-aided identification is includes a two-layered fully connected neural network with 512 neurons in each layer. Transmitter identification occurs at the time steps of the sequence. The results obtained from the position-aided transmitter identification serve as a baseline for evaluating the performance of the transmitter identification process using the receive power vector and the subsequent object association-based transmitter tracking.

To assess the effectiveness of the distributed sensing-aided beam prediction solution, a dataset designed for sensing-aided wireless communication applications in a multi-user scenario is used. The dataset includes multi-modal data, including vision, mmWave wireless communication, GPS data, LiDAR, and radar, collected in a wireless environment. The testbed includes three stationary units, one acting as the base station and the other two acting as the distributed nodes, and a mobile transmitter (vehicle). The stationary units, namely the base station (unit 1), the first distributed node (unit 2), and the second distributed node (unit 3), are equipped with an RGB camera. The base station uses three 16-element (M=16) 60 GHz-band phased arrays, and it receives the transmitted signal using an over-sampled codebook of 64 pre-defined beams (Q=64). In the data collection scenario, the mobile unit (unit 4) is a vehicle equipped with a mmWave transmitter and GPS antenna/receiver. The transmitter includes a quasi-omni antenna transmitting (omnidirectional) at the 60 GHz band.

The evaluation of the distributed sensing-aided beam prediction process uses real-world data obtained from a wireless environment featuring a moving vehicle as the mmWave transmitter. A dataset collected at McAllister Ave., Tempe, during the daytime is used. During the data collection process, the road is actively utilized by vehicles, pedestrians, and cyclists. The dataset includes RGB images from both the base station (unit 1) and the distributed nodes (unit 2 and unit 3), receive power vectors from the three ULAs, and the communication user's GPS position. To prepare the AI-ready dataset for the experiments, the RGB images from unit 2 and unit 3 are processed using a sliding window of size r=5, generating time-series sequences of RGB images for each unit. The AI-ready dataset includes the processed RGB image sequences, along with the receive power at the initial time step, p[τ−r+1], and the optimal beam index f* at the last time step of each sequence. The dataset incorporates the transmitter's GPS position at times t. The sequences where the transmitter car is present in the camera's field of view are retained in the AI-ready dataset. The image sequences are split into training, validation, and testing categories with a ratio of 70:20:10. Separate datasets are constructed for the nodes for the transmitter identification models. The dataset for the position-aided transmitter identification models includes pairs of GPS positions and the corresponding center coordinates of the transmitter's bounding box. The dataset for the receive power-aided transmitter identification models includes pairs of receive power vectors and their corresponding center coordinates. The samples where the transmitter car is present in the scene are selected. The bounding box center coordinates of the transmitter vehicle in these images and their corresponding positions and receive power vectors form the dataset for the transmitter identification models.

Evaluating the performance of the proposed distributed sensing-aided beam prediction solution includes describing the neural network training parameters of the machine learning models and the evaluation metrics that are used to assess the performance of different stages of the process. The distributed sensing-aided beam prediction process includes environment semantics extraction, transmitter identification and tracking, and beam prediction. In the transmitter identification and tracking stage, a two-layered fully connected neural network with 512 neurons in each layer is used to predict the center coordinates of the transmitter's bounding box within the image. For the beam prediction stage, distinct LSTM models are used for bounding box-based beam prediction and mask-based beam prediction, as described herein. In the case of bounding-box based beam prediction, a baseline model including a two-layered FCNN with 512 neurons in each layer is used. For mask-based beam prediction, the LSTM model is used. In the beam prediction classification task, the LSTM models and their respective baselines are trained using cross entropy loss. The receive power-aided transmitter identification FCNN and its corresponding baseline FCNN are trained using mean squared error loss. In the transmitter identification regression task, both the FCNNs, one taking receive power vector as input and the other taking position as input, are trained using mean squared error loss. An Adam optimizer is used to train the aforementioned models. These models are trained on an AI-ready dataset described herein.

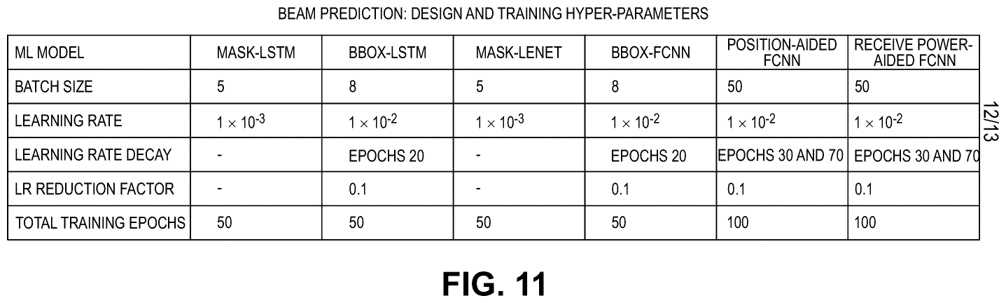

Referring now to FIG. 11, hyperparameters used to fine-tune the models are shown. The evaluation metric used to assess the beam prediction solution is the top-k accuracy, which measures the percentage of test samples where the optimal ground-truth beam falls within the top-k predicted beams. The top-1, top-2 and top-3 accuracies are presented to evaluate the performance of the beam prediction stage. The metric of association accuracy is used to evaluate the performance of tracking the transmitter. The association accuracy for a frame is defined as the percentage of samples for which the transmitter predicted by the receive power-aided FCNN matches with the one predicted by the position-aided FCNN. This calculation assumes that the transmitter was correctly identified in the first frame i.e. both the receive power-based and position-based FCNNs identify the same object as transmitter in the initial frame. In computing association accuracy, the sequences where the difference between the predicted center coordinates by the position-aided FCNN and the center coordinate of the closest bounding box in XBBox and XB-Mask exceeds a specified threshold are not included.

Results from evaluating the object association based-method with respect to tracking the transmitter show how the association accuracy varies against the sequence length with and without semantic-aided filtering. After the transmitter is identified in the first frame of the sequence, the proposed solution involves tracking the transmitter for the next r−1 samples. The differences in results can be associated with different environment conditions, for example, but not limited to, lighting conditions, traffic stoppages, shades and sunny sides that change the color information of the mobile communication user.

The top-1, top-2, and top-3 beam prediction accuracies obtained for units 2 and 3 respectively show differences in performance that can be attributed to the difference in the effectiveness of semantic representations and the difference in the number of training sequences. For instance, masks can capture the communication user's shape and orientation, which may be beneficial for beam prediction.

Beam prediction accuracies from the LSTM models vary with the average number of objects of interest present in the wireless environment for both units 2 and 3. The average is determined by considering the total number of relevant objects across the image samples in the sequence. The beam prediction accuracies remain stable and even increase in some instances as the average number of objects in the wireless environment increases.

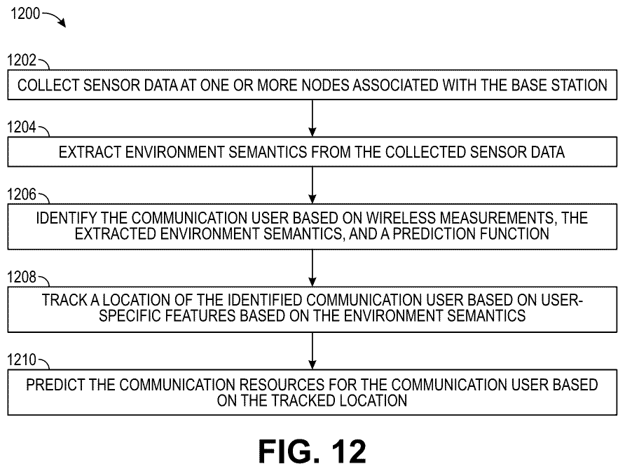

Referring now to FIG. 12, method 1200 for establishing communication resources between a base station and a communication user includes, but is not limited to including, collecting 1202 sensor data at one or more nodes associated with the base station, extracting 1204 environment semantics from the collected sensor data, identifying 1206 the communication user based on the collected sensor data, the extracted environment semantics, and a prediction function, tracking 1208 a location of the identified communication user based on user-specific features based on the environment semantics, and predicting 1210 the communication resources for the communication user based on the tracked location.

Notwithstanding that the numerical ranges and parameters setting forth the broad scope of the disclosure are approximations, the numerical values set forth in the specific examples are reported as precisely as possible. Numerical values may include errors resulting from the standard deviation found in their respective testing measurements. Moreover, ranges disclosed herein are to be understood to encompass sub-ranges subsumed therein.

While the present teachings have been illustrated with respect to one or more implementations, alterations and/or modifications can be made to the illustrated examples without departing from the spirit and scope of the appended claims. In addition, while a particular feature of the present teachings may have been disclosed with respect to one of several implementations, such feature may be combined with one or more other features of the other implementations as may be desired and advantageous for any given or particular function. As used herein, the terms “a”, “an”, and “the” may refer to one or more elements or parts of elements. As used herein, the terms “first” and “second” may refer to two different elements or parts of elements. As used herein, the term “at least one of A and B” with respect to a listing of items such as, for example, A and B, means A alone, B alone, or A and B. Those skilled in the art will recognize that these and other variations are possible. Furthermore, to the extent that the terms “including,” “includes,” “having,” “has,” “with,” or variants thereof are used in either the detailed description and the claims, such terms are intended to be inclusive in a manner similar to the term “comprising.” Further, in the discussion and claims herein, the term “about” indicates that the value listed may be somewhat altered, as long as the alteration does not result in nonconformance of the process or structure to the intended purpose described herein. Finally, “exemplary” indicates the description is used as an example, rather than implying that it is an ideal.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompasses by the following claims.

1. A method for establishing communication resources between a base station and a communication user, the method comprising:
collecting sensor data at one or more nodes associated with the base station;
extracting environment semantics from the collected sensor data;
identifying the communication user based on wireless measurements, the extracted environment semantics, and a prediction function;
tracking a location of the identified communication user based on user-specific features based on the environment semantics; and
predicting the communication resources for the communication user based on the tracked location.

2. The method of claim 1, wherein the sensor data comprise:
one or more of RGB images, LiDAR data, radar data, and GPS data.

3. The method of claim 1, wherein the environment semantics comprise:
one or more bounding boxes, one or more binary masks, a mobility pattern of the communication user, and direction of travel of the communication user.

4. The method of claim 3, wherein extracting the environment semantics comprises:
generating, by the one or more nodes, the one or more bounding boxes and the one or more binary masks based at least on object detection and an image segmentation model.

5. The method of claim 3, further comprising:
removing one or more of the one or more bounding boxes that do not contain the location of the communication user by filtering, using a nearest neighbor algorithm with a Euclidean distance metric, the one or more bounding boxes.

6. The method of claim 3, wherein the environment semantics comprise:
center coordinates of the one or more bounding boxes.

7. The method of claim 1, wherein extracting the environment semantics comprises:
executing a YOLO model in the one or more nodes.

8. The method of claim 1, wherein tracking the location of the identified communication user comprises:
using data samples based on bounding box-based object tracking.

9. The method of claim 8, wherein the bounding box-based object tracking comprises:
finding a closest bounding box to the communication user using a Euclidean distance-based object association algorithm.

10. The method of claim 1, wherein the prediction function comprises:
a machine learning model configured to predict a probable location of the communication user.

11. The method of claim 10, wherein tracking the location of the identified communication user comprises:
tracking by the user-specific features combined with a Hadamard product to identify the communication user based on color similarity.

12. The method of claim 1, wherein predicting the communication resources comprises:
single instance-based beam prediction based on bounding boxes or a mask and a mapping function at a step time to predict a communication resource index.

13. The method of claim 1, wherein predicting the communication resources comprises:
processing a sequence of the user-specific features based on a recurrent neural network (RNN).

14. The method of claim 13, further comprising:
predicting a communication resources index based on a mapping function used by the RNN.

15. A computer system for establishing communication resources between a base station and a communication user, the computer system comprising:
a hardware processor; and
a non-volatile storage medium storing instructions that when executed by the hardware processor perform operations comprising:
collecting sensor data at one or more nodes associated with the base station;
extracting environment semantics from the collected sensor data;
identifying the communication user based on wireless measurements, the extracted environment semantics, and a prediction function;
tracking a location of the identified communication user based on user-specific features based on the environment semantics; and
predicting the communication resources for the communication user based on the tracked location.

16. The computer system of claim 15, wherein the sensor data comprise:
one or more of RGB images, LiDAR data, radar data, and GPS data.

17. The computer system of claim 15, wherein the environment semantics comprise:
one or more bounding boxes, one or more binary masks, a mobility pattern of the communication user, and direction of travel of the communication user.

18. The computer system of claim 17, wherein extracting the environment semantics comprises:
generating, by the one or more nodes, the one or more bounding boxes and the one or more binary masks based at least on object detection and an image segmentation model.

19. The computer system of claim 17, wherein the operations further comprise:
removing the one or more of the one or more bounding boxes that do not contain the location of the communication user by filtering, using a nearest neighbor algorithm with a Euclidean distance metric, the one or more bounding boxes.

20. A computer program product for establishing communication resources between a base station and a communication user, the computer program product comprising a computer readable storage medium having program instructions embodied therewith, the program instructions executable by a computing device to cause the computing device to perform operations comprising:
collecting sensor data at one or more nodes associated with the base station;
extracting environment semantics from the collected sensor data;
identifying the communication user based on wireless measurements, the extracted environment semantics, and a prediction function;
tracking a location of the identified communication user based on user-specific features based on the environment semantics; and
predicting the communication resources for the communication user based on the tracked location.

21. The computer program product of claim 20, wherein the wireless measurements comprise at least one of:
a receive power vector; or
a compressive sensing-based measurements vector.

22. The computer program product of claim 20, wherein the communication resources comprise at least one of:
a communication beam;
time-frequency resources; or
a hand-off decision.
